(19) United States
(12) Patent Application Publication
(10) Pub. No.: US 2010/0279125 A1
(43) Pub. Date: Nov. 4, 2010

(54) Film comprising substrate-free polymer dispersed liquid crystal; fiber, fabric, and device thereof; and methods thereof

(75) Inventors: Ebru A. Buyuktanir, Wooster, OH (US); John L. West, Hartville, OH (US)

Correspondence Address: FAY SHARPE LLP, 1228 Euclid Avenue, 5th Floor, The Halle Building, Cleveland, OH, 44115, US

(73) Assignee: Kent State University

(21) Appl. No.: 12/799,655

(22) Filed: Apr. 29, 2010

Related U.S. Application Data
(60) Provisional application No. 61/173,804, filed on Apr. 29, 2009.

(51) Int. Cl. B32B 17/06; C09K 19/00; C09K 19/60; B32B 9/04; B05D 3/02; B05D 3/06; B05D 1/36; B29C 55/00; B29C 71/02; B29C 35/08; B05D 1/02; B05D 1/18; B05D 5/12; B32B 37/14

(52) U.S. Cl. 428/432; 252/299.01; 252/299.1; 428/411.1; 428/702; 427/385.5; 427/508; 427/407.1; 264/291; 264/236; 264/494; 427/427.6; 427/427.7; 427/431; 427/430.1; 427/123; 264/129; 156/60

(57) ABSTRACT

The invention provides a film comprising a polymer dispersed liquid crystal (PDLC) which exists independently from a substrate, i.e. a substrate-free PDLC; a fiber, a fabric, and a device thereof; and methods thereof. In an embodiment, a mixture comprising liquid crystal and monomers floats and is spread over a liquid base, before polymerization the mixture into a layer of polymer matrix dispersed with liquid crystal domains. The invention exhibits numerous technical merits such as improved transmittance, enhanced brightness, easier manufacturability, more flexible manufacturability, better cost-effectiveness, enhanced electro-optical performance, and improved device uniformity, among others.

This application claims priority based on the U.S. Provisional Application 61/173,804 filed on Apr. 29, 2009, which is incorporated herein by reference in its entirety.

### FIELD OF THE INVENTION

The present invention relates to a film comprising polymer dispersed liquid crystal (PDLC) which exists independently from a substrate, i.e. a substrate-free PDLC; to a fiber, a fabric, and/or a device including the same; and to methods of making the same. The invention finds particular application in conjunction with any of the following devices: light modulating device, a display device, a light shutter, a switchable window, a projection display, a direct-view display, portable electronics, high-tech fabrics and textiles, adaptive liquid crystal lenses with variable focus, curved optical devices, tunable filters, optical memory storage, bistable devices, holographically patterned substrate-free PDLC films, a stimuli responsive optoelectronic fiber/fabric, an optical sensor, substrate-free PDLC photonic materials, and a flexible LC display, and will be described with particular reference thereto. However, it is to be appreciated that the present invention is also amenable to other like applications.

### BACKGROUND OF THE INVENTION

The study of phase separated liquid crystal polymer composite structures has existed as an established field since the 1980s. Polymer dispersed liquid crystal (PDLC) systems, polymer stabilized liquid crystals, polymer wall/liquid crystal (LC) composites, anisotropic phase separated composite films, and infiltrated LCs in templates are the most common composite systems that have been used to fabricate robust LC displays.

Over years, these composite systems have proven to be a reliable solution for many kinds of LC applications, such as light shutters, switchable windows, projection displays, direct-view displays, and portable electronics. More recently, these materials have become great candidates for flexible LC display applications, as disclosed in E. A. Buyuktanir, M. Mitrokhin, B. Holter, A. Glushchenko, and J. L. West, Jpn. J. Appl. Phys. 45 (5), 4146-4151 (2006); and A. Khan, I. Shiyanovskaya, T. Schneider, N. Miller, T. Ernst et al., J. of the SID 13 (6), 469 (2005).

Stressed liquid crystals (SLCs) are another important class of LC/polymer composite displays reported and patented by West et al. in J. L. West, K. Zhang, M. Zhang, E. Büyüktanir, and A. Glushchenko, Proc. SPIE 5936, 59360L (2005). These displays present the largest phase retardation shift achievable within the shortest time interval. A device incorporating such displays was prepared by UV-polymerization of a LC/monomer mixture between two glass substrates, and later, the LC cell is stressed mechanically in one direction. The applied stress force to the cell aligns the LC domains dispersed in a polymer matrix and eliminates scattering and hysteresis at the same time. The resulting display can be used as micro-displays, diffractive optical elements, and beam steering devices.

There are many advantages of the mentioned LC/polymer composite systems when compared to other liquid crystal display (LCD) modes. For example, the advantages of droplet morphology in LC films as compared to twisted-nematic (TN) cells can be summarized as follows: ease of large-area display manufacturing; high brightness can be achieved because in most cases polarizers are not required; birefringent plastic substrates can be utilized; and the electro-optical properties of the device can be tailored according to the composition and the polymerization conditions used.

Since the polymer material usually occupies a large volume fraction of the LC/polymer composite display, it serves a number of critical functions: it provides mechanical support (ruggedness); it determines the thermomechanical stability of the composite; it protects the display functionality from the environment; it helps to distribute the applied pressure by acting as a stress transfer medium i.e., it is self-sustaining; it provides durability, interlaminar toughness and shear/compressive/transverse strengths to the system in general; and it maintains the cell gap of the display.

The formation of PDLC devices can be acquired by three main types of phase separation methods: polymerization induced phase separation (PIPS); thermally induced phase separation (TIPS); and solvent induced phase separation (SIPS). In the TIPS method, a homogeneous mixture of liquid crystal and polymer melt is prepared and the mixture is cooled at a specific rate to induce phase separation. In the SIPS method, a liquid crystal material and a liquid polymer precursor are mixed together, and the mixture is then cast into a film. The PIPS method provides homogeneity and forms a cross-linked structure of polymer that renders it insensitive to temperature changes. In addition, the PIPS method also allows better control over the morphology of the polymer structure, and enables the production of large flexible panels.

Traditionally, small size (less than 2 inches by 2 inches) PDLC cells are prepared by drop-filling the LC/prepolymer mixture (dropping the mixture onto the bottom glass substrate before covering with the top glass substrate) between two conducting layers (e.g. ITO, conducting polymers) and coated glass substrates. Finally, the cell is irradiated with UV light.

Flexible PDLC films are generally produced by a lamination method, which facilitates easy fabrication of large area flexible devices. The first step is to place a sheet of plastic substrate on a smooth surface. Then the LC/prepolymer mixture is spread across the surface of the plastic substrate. Finally, the second plastic substrate is laminated onto the bottom substrate by means of a rubber roller and the cell is UV-cured.

The electro-optical characteristics of the PDLC film depend strongly on the morphology of PDLC composites, which can be modified by varying LC concentration, additives, polymer type, irradiation dose (for PIPS method), and polymerization temperature.

The operating mechanism of a typical PDLC electro-optical device is based on the manipulation of the refractive index variation by changing the orientation of LC molecules within the droplets by an external force. Generally speaking, the electrically controllable light scattering feature (or opaque state) can be realized when the field is off, where the symmetry axis of each droplet is randomly oriented. The transparent (or clear) state can be achieved when the LC molecules are aligned along the field, where the refractive index of a polymer matrix (nₚ) matches to the ordinary refractive index nₒ of a liquid crystal molecule. Therefore, normally incident light travels through the PDLC film without scattering and the film looks transparent.

Advantageously, the present invention provides a film comprising polymer dispersed liquid crystal (PDLC) which exists independently from a substrate, i.e. a substrate-free PDLC; a fiber, a fabric, and a device thereof; and methods thereof. The invention exhibits numerous technical merits such as improved transmittance, enhanced brightness, easier manufacturability, more flexible manufacturability, better cost-effectiveness, enhanced electro-optical performance, and improved device uniformity, among others.

### BRIEF DESCRIPTION OF THE INVENTION

One aspect of the invention provides a film comprising a polymer dispersed liquid crystal (PDLC) which exists independently from a substrate, i.e. a substrate-free PDLC.

Another aspect of the invention provides a fiber made from a film comprising substrate-free PDLC and a fabric made from such fibers.

Still another aspect of the invention provides a PDLC device including a film comprising substrate-free PDLC.

Yet another aspect of the invention provides a PDLC device including a fiber made from a film comprising substrate-free PDLC and a fabric made from such fibers.

Still another aspect of the invention provides a method of preparing a film comprising a substrate-free PDLC, which comprises:

providing a first liquid base;

providing a mixture comprising liquid crystal and monomers, wherein the liquid crystal and the monomers are substantially insoluble in the first liquid base;

spreading the mixture on the surface of the first liquid base; and

forming a layer of polymer matrix dispersed with liquid crystal domains on the surface of the first liquid base.

Still another aspect of the invention provides a method of preparing a PDLC fiber, which comprises:

providing a first liquid base;

providing a mixture comprising liquid crystal and monomers, wherein the liquid crystal and the monomers are substantially insoluble in the first liquid base;

spreading the mixture on the surface of the first liquid base;

forming a PDLC layer of polymer matrix dispersed with liquid crystal domains on the surface of the first liquid base; and

elongating the PDLC layer to form a PDLC fiber.

A further aspect of the invention provides a method of preparing a PDLC device, which comprises:

providing a first liquid base;

providing a mixture comprising liquid crystal and monomers, wherein the liquid crystal and the monomers are substantially insoluble in the first liquid base;

spreading the mixture on the surface of the first liquid base;

forming a PDLC layer with polymer matrix dispersed with liquid crystal domains on the surface of the first liquid base; and

transferring the PDLC layer onto a medium or sandwiching the PDLC layer between two mediums.

### BRIEF DESCRIPTION OF THE DRAWINGS

FIG. 1 shows the light transmissions (%) of indium-tin-oxide (ITO) coated glass and ITO-coated plastic (PET) substrates as measured by UV-VIS spectroscopy;

FIG. 2a illustrates a step in the preparation of a substrate-free PDLC film by a polymerization-induced phase separation (PIPS) process, in which a LC/monomer mixture is stirred at a temperature above the nematic-isotropic transition temperature (T_{NI}) of the LC material, in accord with an embodiment of the invention;

FIG. 2b illustrates the cross section of an experimental set-up before polymerization in accord with an embodiment of the invention;

FIG. 2c illustrates the cross section of an experimental set-up during UV-irradiation to induce the PIPS process, in accord with an embodiment of the invention;

FIG. 3a illustrates the cross section of a substrate-free PDLC film after it is drawn from the surface of a liquid in accord with an embodiment of the invention;

FIG. 3b shows the POM picture of interconnected polymer cavities when the polarizer is perpendicular to the analyzer, in accord with an embodiment of the invention, in which the film was prepared from nematic LC and thiol-ene based monomer and later washed with hexane;

FIG. 3c shows the POM picture of interconnected polymer cavities when the polarizer is parallel to the analyzer in accord with an embodiment of the invention, in which the film was prepared from nematic LC and thiol-ene based monomer and later washed with hexane;

FIG. 3d shows the photograph of a substrate-free PDLC film with a thickness of approximately 100 μm after the polymerization process in accord with an embodiment of the invention;

FIG. 4 schematically demonstrates the cross section of a liquid crystal device with a substrate-free PDLC film in accord with an embodiment of the invention;

FIG. 5 shows the cross section of a liquid crystal device consisting of a substrate-free PDLC film, top and bottom extra polymer layers, and two conductive substrates in accord with an embodiment of the invention;

FIG. 6a shows the POM picture of a PDLC fiber (nematic phase) drawn from a polymerized substrate-free PDLC film prepared on the liquid surface with colors believed due to the birefringence of the LC domains dispersed in the polymer matrix in accord with an embodiment of the invention, in which the long fiber axis is placed at 45 degree between crossed polarizer and analyzer;

FIG. 6b shows the POM picture of a PDLC fiber above nematic-isotropic transition temperature (T_{NI}) in an accord with embodiment of the invention, wherein the material exhibits only liquid phase, and the bright lines in the picture (with 50× microscope objective) are polymer chains;

FIG. 6c shows the POM picture of a PDLC fiber (at the nematic phase), which is placed at 45 degree between crossed polarizer and analyzer in accord with an embodiment of the invention, demonstrating the polarization rotation of the light propagating through the fiber;

FIG. 6d shows the POM picture of a PDLC fiber (at the nematic phase), which is placed along the polarizer in accord with an embodiment of the invention, demonstrating the light propagating through the fiber is blocked by aligning the long axis of the fiber along the polarizer;

FIG. 7 illustrates the cross section of an experimental set-up during UV irradiation in order to prepare a substrate-free PDLC film in accord with an embodiment of the invention. Prior to UV irradiation, a LC and monomer mixture is injected between top and bottom liquid surfaces and followed by polymerization-induced phase separation process;

FIG. 8 demonstrates the scanning electron microscopy (SEM) image of the cross section of a 5 μm thick substrate-free PDLC film;

Panels (a) and (b) in FIG. 9 show the POM images of a PDLC fiber at a temperature below and above nematic-isotropic phase transition temperature in the nematic phase;

Panels (c) and (d) in FIG. 9 show the SEM images of PDLC fiber with different magnifications with highly elongated fibrilar polymer structure;

FIG. 10 show the POM images of a PDLC fiber when the fiber was rotated at different angles under crossed polarizers; and

FIG. 11 shows the electro-optical characterizations of PDLC fibers including electro-optical responses to square-wave voltage pulses and the response time characteristics; and light transmission characteristics.

### DETAILED DESCRIPTION OF THE INVENTION

All of the cited references are incorporated in the present invention in their entirety. The term “substrate-free PDLC” is herein defined as polymer dispersed liquid crystal (PDLC) which exists independently from a substrate. “LC” is the abbreviation for liquid crystal; “PET” is the abbreviation for poly(ethylene terephtalate); “ITO” is the abbreviation for Indium-tin-oxide; “OTFT” is the abbreviation for organic-thin-film-transistor; “PIPS” is the abbreviation for polymer-induced phase separation; “TIPS” is the abbreviation for thermally induced phase separation; “SIPS” is the abbreviation for solvent induced phase separation; “AC” is the abbreviation for alternating current; “POM” is the abbreviation for Polarizing Optical Microscopy; “SLC” is the abbreviation for Stressed Liquid Crystal; “T_{NI}” is the abbreviation for nematic to isotropic phase transition temperature; and “μm” denotes micrometer.

The invention provides a film comprising a substrate-free PDLC, and examples of the substrate divorced from PDLC may be, for example, a rigid and transparent material such as glass and plastic. In various embodiments, the concentration of the liquid crystal in the film may be generally from about 10% to about 95% by weight, based on the total weight of the polymer and the liquid crystal. For example, the polymer may function as a matrix containing liquid crystal droplets.

The mesophases of the liquid crystal material may be selected from, for example, nematic, cholesteric (chiral nematic), smectic such as smectic A, smectic C, Smectic C* (chiral smectic C), ferroelectric and antiferroelectric smectic mesophases, and higher order smectics of B, E, G, H, J, and K-types; banana mesophase; lyotropic chromonic liquid crystals; and columnar mesophase.

The polymer in the film may be made from photo-polymerizable monomers selected from thiol-ene systems; monomers such as acrylates through radical polymerization; ring-opening monomers such as epoxides through cationic polymerization; photo-polymerizable blends such as nematogenic monomer and chiral dopants and polyurethane/acrylate blends; photo-polymerizable cholesteric mixtures; photo-polymerizable biomaterials; any copolymer thereof such as block copolymer; and any mixture thereof.

In some embodiments, the polymer may be made from thermal-polymerizable monomers selected from epoxy resins, polyurethanes, acrylic resins, matrices of bismaleidimide, phenolic, polyesters, polyimides, blends of polymer and monomers, and blends of monomers.

The polymer may also be made from a combination of thermal-polymerizable monomers and photo-polymerizable monomers.

The prepolymer (monomer) is preferably chosen from those that can be polymerized by photo-polymerization, such as photoinitiated radical polymerization (e.g., acrylates), cationic photopolymerization (e.g. ring-opening reaction of epoxides), and thiol-ene systems etc. The thiol-ene systems are preferred as they exhibit rapid reaction, low shrinkage, little or no oxygen inhibition, self initiation, and formulation latitude. In addition to a photopolymerization method, the thermal curing of prepolymers by means of heat with or without catalysts, hardeners, and modifiers may be used to produce polymer matrices for the liquid crystal/polymer composites on the liquid surface. Among them, epoxy resins, polyurethanes, acrylic resins, and matrices of bismaleidimide, phenolic, polyesters, and polyimides are common examples for thermosetting polymers that can be used for the formulation of the liquid crystal/polymer composites.

The film of the invention may further comprise one or more suitable additives, for example, dyes such as positive and negative dichroic dyes, dopants, surfactants, ferroelectric particles, ferromagnetic particles, macromolecules, piezoelectric particles, multifunctional monomers, azo dyes, biological materials, colloidal particles, mesogens, gold particles, metal particles, adhesives, chemical markers, fluorescent dyes, minerals, and quantum dots.

By introducing positive and negative dichroic dyes into the formulation, it may be possible to change the optical state of the film by stretching the film mechanically or by applying an electric field. The additional compounds such as dyes, dopants, and/or initiators, surfactants, ferroparticles, magnetic particles, and macromolecules may be added to the formulation and/or to the liquid media.

In some embodiments, the film of the invention comprises a layer of polymer dispersed liquid crystal (PDLC), and one layer of polymer free of liquid crystal on one side of the layer of polymer dispersed liquid crystal (PDLC). The film may also comprise a layer of polymer dispersed liquid crystal (PDLC), and two layers of polymer free of liquid crystal on two sides of the layer of polymer dispersed liquid crystal (PDLC) respectively.

The invention provides a PDLC device including a film comprising substrate-free PDLC. Examples of such devices include, but are not limited to, a light modulating device, a display device, a light shutter, a switchable window, a projection display, a direct-view display, portable electronics, high-tech fabrics and textiles, adaptive liquid crystal lenses with variable focus, curved optical devices, tunable filters, optical memory storage, bistable devices, holographically patterned substrate-free PDLC films, substrate-free PDLC photonic materials, and a flexible LC display. In some embodiments, the PDLC devices of the invention may further include one medium onto which the film is transferred or two mediums between which the film is sandwiched. For example, the medium may be selected from an indium-tin-oxide coated glass substrate, an indium-tin-oxide coated plastic substrate, a flexible or rigid surface coated with a conducting layer, a textile surface embedded with an organic-thin-film-transistor (OTFT), a conducting polymer, an inorganic conductor, and a hybrid organic-inorganic conductor.

In various embodiments, a fiber may be made from the film comprising the substrate-free PDLC. Such fibers may be woven into a fabric with any shape. The invention also provides a PDLC device including a fiber made from the film comprising substrate-free PDLC or a fabric thereof, for example, a stimuli responsive optoelectronic fiber/fabric, an optical sensor, and a light modulating device.

Optical responses and properties of the fibers, such as transparency, opacity, phase retardation, reflective colors, and birefringence, can be altered by constructing a liquid crystal display device consisting of a fiber between two conducting substrates and either by the application of electric and magnetic fields or by employing mechanical stress (tension or compression) directly to the PDLC fiber obtained from a substrate-free PDLC film. These fibers can also be woven as a fabric and can be used to form high-tech textiles with or without flexible or rigid substrates, and with or without conducting or nonconducting layers. If the fiber is made up of cholesteric LCs, the fiber is expected to change its reflective colors on application of external stimulus, for example temperature, stress, or electric field. These fibers, for instance, can be used to form fabrics for medical applications, such as to measure the distribution of body temperature. It is a noninvasive tool to monitor patients. PDLC fiber can also be used for photonic fiber optic applications. In addition, deformation of the PDLC fibers and films may induce flexoelectric effect under bend deformation, or conversely, the deformation of the director due to an applied electric field, in that the liquid crystal component of the PDLC fiber or films is formed from molecules with a shape asymmetry, such as banana shaped or wedge shaped liquid crystal molecules.

These stretchable and bendable optical fibers and films can be engineered to form materials and devices, responding to chemical changes or thermal and mechanical effects, as well as the application of electric and magnetic fields. They can be utilized in a variety of photonic applications ranging from optical sensors to light modulating devices operating in the UV-VIS to IR regions of the electromagnetic spectra. Additionally, the chemistry of the fiber or film can be changed to detect other chemicals present in the surrounding environment by observing texture, color, or shape changes. The reflective mode of cholesteric liquid crystal mesophase can also be used to form high-tech fabrics functioning as a thermo-optic device embedded or woven into clothing. In general, PDLC fibers can be used to produce stimuli responsive and/or interactive high-tech fibers/fabrics. External stimuli include electric field, magnetic field, heat, mechanical stress, chemical changes, and photonic radiation.

The method of preparing a film comprising substrate-free PDLC may comprise:

providing a first liquid base such as water, organic solvents, polymer solutions, or any combination thereof;

providing a mixture comprising liquid crystal and monomers, wherein the liquid crystal and the monomers are substantially insoluble in the first liquid base;

spreading the mixture on the surface of the first liquid base; and

forming a layer of polymer matrix dispersed with liquid crystal domains on the surface of the first liquid base. In embodiments, this step is accomplished by UV curing, thermal curing, solvent evaporation, or any combination thereof.

In spreading the mixture on the surface of the first liquid base, the density of the liquid crystal and the density of the monomers may be so selected that they are both lower than the density of the first liquid base. However, it should be understood that the density is not the only reason that the mixture floats on the surface of the liquid. It is possible to float or spread higher density material (liquid or solid) on the liquid surface by the help of surface tension of the liquid base and the interfacial tension that exists between them.

In a specific embodiment, the step of forming a layer of polymer matrix dispersed with liquid crystal domains is accomplished by polymer-induced phase separation (PIPS), which may be conducted with a UV radiation dose of from about 0.01 milliWatt per square centimeter (mW/cm²) to about 500 mW/cm². The polymer-induced phase separation (PIPS) is conducted at a polymerization temperature of, for example, from about 0° C. to about 250° C.

In some embodiments, since a polymer matrix containing liquid crystal droplets is initially formed without substrates, it can be transferred very easily onto any media, such as onto an indium-tin-oxide coated glass substrate, plastic substrate, or any flexible or rigid surface coated with one or more conducting layers.

In an embodiment, the film preparation comprises:

providing a first liquid base;

providing a second liquid base;

providing a mixture comprising liquid crystal and monomers, wherein the liquid crystal and the monomers are substantially insoluble in the first and second liquid bases

spreading the mixture on the surface of the first liquid base to form a layer;

spreading the second liquid base on the layer of the mixture; and

forming a layer of polymer matrix dispersed with liquid crystal domains between the first liquid base and the second liquid base.

In spreading the mixture on the surface of the first liquid base to form a layer and spreading the second liquid base on the layer of the mixture, the density of the liquid crystal and the density of the monomers may be so selected that they are both lower than the density of the first liquid base but higher than the density of the second liquid base. However, it should be understood that the density is not the only reason that the mixture floats on the surface of the liquid. It is possible to float or spread higher density material (liquid or solid) on the liquid surface by the help of surface tension of the liquid base and the interfacial tension that exists between them.

The present invention also provides a method of preparing a PDLC fiber, which comprises:
(i) providing a first liquid base;
(ii) providing a mixture comprising liquid crystal and monomers, wherein the liquid crystal and the monomers are substantially insoluble in the first liquid base;
(iii) spreading the mixture on the surface of the first liquid base;
(iv) forming a PDLC layer of polymer matrix dispersed with liquid crystal domains on the surface of the first liquid base; and
(v) elongating the PDLC layer to form a PDLC fiber.

In steps (iv) and (v), the PDLC layer of polymer matrix may be cured completely. Alternatively, the PDLC layer of polymer matrix may be cured incompletely and then the fiber is transferred onto another surface to be cured with UV light, heat, or a combination thereof.

In some embodiments, the fiber preparation method of the invention may further comprise the step of modifying the surface characteristics of the fiber by dipping, spraying, or coating the fiber with another layer of polymer, curable monomers, surfactants, or any combination thereof.

In an embodiment, fiber material characteristics, as well as elastic and mechanical properties, are changed as a result of changing the formulation and processing parameters of PDLC films.

The present invention provides a method of preparing a PDLC device, which comprises:

providing a first liquid base;

providing a mixture comprising liquid crystal and monomers, wherein the liquid crystal and the monomers are substantially insoluble in the first liquid base;

spreading the mixture on the surface of the first liquid base;

forming a PDLC layer with polymer matrix dispersed with liquid crystal domains on the surface of the first liquid base; and

transferring the PDLC layer onto a medium or sandwiching the PDLC layer between two mediums. Examples of the medium include, but are not limited to, an indium-tin-oxide coated glass substrate, a plastic substrate, a flexible or rigid surface coated with a conducting layer, a textile surface embedded with an organic-thin-film-transistor (OTFT), a conducting polymer, an inorganic conductor, and a hybrid organic-inorganic conductor.

In a variety of exemplary embodiments, the present invention provides light modulating devices utilizing electrically switchable polymer dispersed liquid crystal (PDLC) films and fibers, and a fabrication method thereof. Particularly, the present invention provides a substrate-free PDLC display component in which the PDLC film is formed without top and bottom substrates and the fabrication thereof. The PDLC fibers are drawn from thin substrate-free PDLC films prepared on the water surface. These substrate-free PDLCs films and fibers offer novel functionalities, flexibility, and enhanced electro-optical performance over glass based LC/polymer composites when subjected to external stimulus, such as electromagnetic fields and mechanical deformation. In addition, these films and fibers can be stretched in any direction to modify optical characteristics and electro-optical responses. Mechanically stretched thin LC films and fibers can be switched electrically, and therefore, can potentially be used as high-tech fabrics, fiber optics, and light modulating devices.

In a variety of exemplary embodiments, the invention provides a substrate-free flexible PDLC component of the device that was polymerized on the liquid surface by using the polymer-induced phase separation (PIPS) method. Since the polymer matrix containing LC droplets was initially formed without substrates, PDLC film and fiber can be transferred very easily onto any media, such as on indium-tin-oxide (ITO) coated glass or plastic substrates, or textile surfaces embedded with organic-thin-film-transistor (OTFT) to switch the display. Alternatively, conducting polymers can be directly printed or coated onto the film surface. Conducting fibers (melt spun or electrospun) can also be used to switch the films. These fiber and film structures may be embedded with conducting wires, or incorporated into a thin film and/or core-shell structure embedded with conducting organic, inorganic or polymeric materials, wires, circuit, or metal electrodes.

The substrate-free films and fibers drawn from these films can also be easily sandwiched between ITO-coated plastic or glass substrates in order to form a switchable PDLC film. The intensity of the transmitted light can be varied by changing the orientation of the LC molecules inside the droplets via an application of an electric field or by stretching. Conducting polymers, inorganic conductors, and/or hybrid organic-inorganic conductors can be applied to the top and bottom of the substrate-free PDLC films and fibers in order to obtain electro-optical responses. The substrate-free PDLC film production can be adapted in the roll-to-roll display manufacturing process. This display can be used as switchable windows, displays to be used as advertisement or information boards, and high-tech fabric displays that can be switched between light scattering opaque and transparent states by applying an alternating current (AC) electric field. The PDLC fibers can be used to produce electrically controlled polarizers. The operating principle of a PDLC fiber polarizer is based on anisotropic light scattering of PDLC fibers resulting from unidirectionally oriented LC domains dispersed in a stretched polymer structure. These polarizers will provide light amplitude and phase modulations.

In a variety of exemplary embodiments, the method of the invention may reduce the PDLC window production cost dramatically by eliminating the lamination of the film between two ITO-coated plastic substrates. Instead, the substrate-free and very flexible PDLC film can be sandwiched directly between two ITO-coated glass substrates or the like. It is expected that once the plastic substrate film and the lamination method are eliminated, the cost of the manufacturing of the PDLC display may decrease. The uniformity of the device may also increase substantially.

The method of the invention enables the single-step photo-polymerization of the LC/prepolymer composite films and fibers, where a light modulating LC material formed of a birefringent liquid crystal is interspersed as spherical or randomly distorted droplets in an isotropic polymer. It also eliminates other costly and complex methods, such as carrier-substrates and lift-off processes, for manufacturing a fully flexible liquid crystal display component.

### Example 1

### Transmittance Comparison

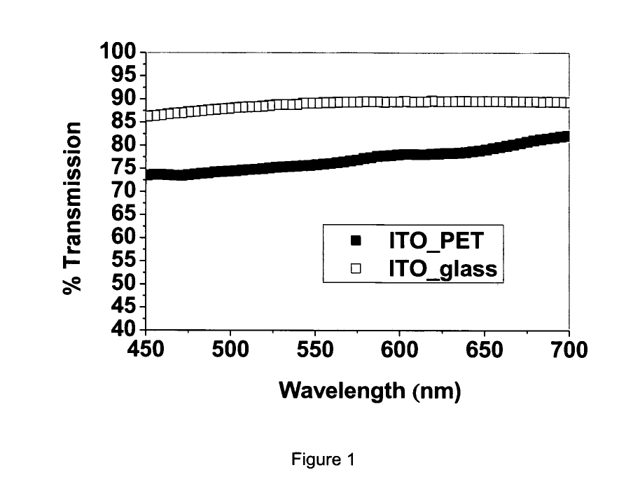

This example shows the improvement of device brightness by eliminating the plastic substrates completely from the production of large-area PDLC units. A commercially available ITO-coated poly(ethylene terephtalate) (PET) substrate (127 micrometer thick) from Southwall Technologies Inc. (Palo Alto, Calif., USA) was purchased, and its transmittance % was measured in the visible region (450-700 nm) of the electromagnetic spectrum. A commercially available ITO-coated glass substrate (1.1 millimeter thick) from Corning Incorporation with Code 7059 was prepared for comparison, and its transmittance % was similarly measured. Samples of size 3 cm×3 cm were cut and placed inside the spectrometer. Light transmittance values were measured for both samples using a Lambda 19 Perkin Elmer UV/VIS/NIR Spectrometer at room temperature in the visible region. FIG. 1 shows the light transmissions (%) of indium-tin-oxide (ITO) coated glass and ITO-coated plastic (PET) substrate as measured by UV-VIS spectroscopy. As seen in FIG. 1, the ITO-PET sample transmits light approximately 10% less than the ITO-glass sample.

### Example 2

### Substrate-Free PDLC Film Preparation

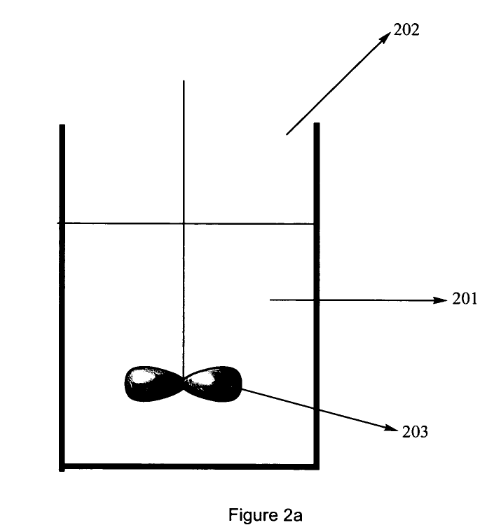

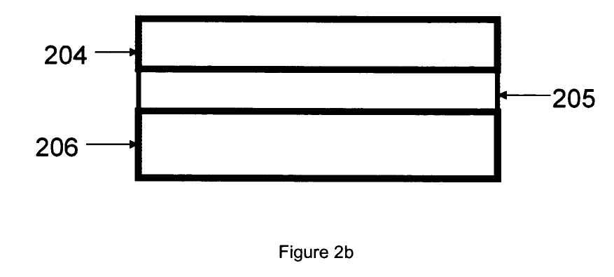

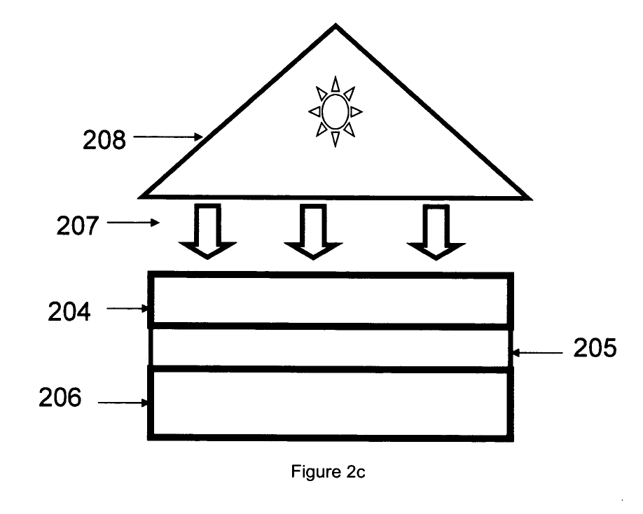

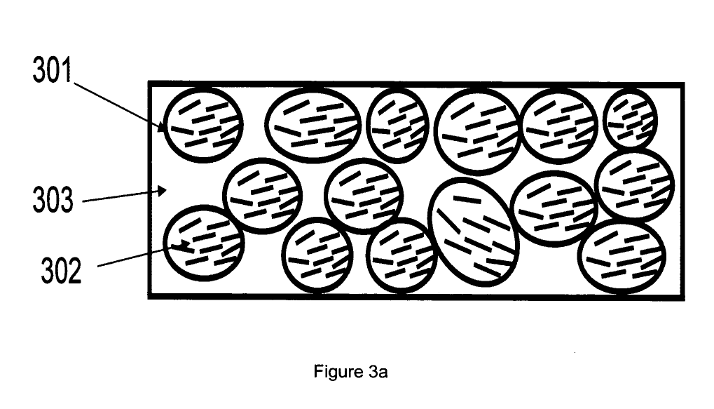

FIG. 2a illustrates a step in the preparation of a substrate-free PDLC film by the polymerization-induced phase separation (PIPS) process. With reference to FIG. 2a, a LC/prepolymer mixture 201 was prepared in a vial with the desired weight ratio 50/50 wt %. The prepolymer used was polymer precursor NOA65 manufactured by and commercially available from Norland Products with a refractive index of 1.525 and the liquid crystal mixture E7 was obtained from Merck Ltd., GB which consists of 51.0% of 4-pentyl-4′-cyanobiphenyl, 25.0% of 4-heptyl-4′-cyanobiphenyl, 16.0% of 4-octoxy-4′-cyanobiphenyl, and 8.0% of 4-peptyl-4′-cyanoterphenyl. The amount of prepolymer and liquid crystal in the mixture can be varied from 5 to 95 parts by weight based on total 100 parts by weight of the LC/prepolymer composition. Next, the liquid was poured into a container 202 and heated up to 25° C., and the LC/monomer mixture was stirred with a stirrer 203 at above T_{NI} of the LC material. Later, the LC/prepolymer mixture was dispensed onto the liquid (water) surface by a pipet.

FIG. 2b illustrates the cross section of an experimental set-up before the polymerization. With reference to FIG. 2b, the LC/prepolymer mixture 204, as a separate layer, floats on top of the surface of a liquid (water) base 205. Liquid base 205 sits on a digitally controlled heating/cooling plate 206, which is Haake A80 commercially available from Haake Inc., Saddle Brook, N.J.

FIG. 2c illustrates the cross section of an experimental set-up during UV-irradiation to induce the PIPS process. With reference to FIG. 2c, the coating layer 204 on the liquid base 205 surface is completely cured without a mask using UV-light radiation 207 from a UV-light source 208, which is an Electro-Lite Corporation ELC 4000 light curing unit to induce phase separation. A polymer dispersed liquid crystal film was formed between the liquid base 205 and air. In this example, nematic LC and thiol-ene based monomer were mixed at 50 to 50 weight ratio and the mixture was dispensed onto the aqueous surface, and UV-polymerized at room temperature.

It is possible to change the size and the shape of the droplet structure as well as completely alter the morphology of the final film by varying the experimental parameters, such as UV light intensity, temperature, formulation of the mixture, the weight ratio of monomer to LC in the mixture, type and temperature of the liquid. In addition, external or internal masks can be used to change the morphology and topology of the polymerized film and fibers. For instance, it is possible to obtain substrate-free PDLC lenses by using specially design masks to pattern the film.

The side of the LC/prepolymer mixture in contact with the liquid is called the liquid-side, and the other side is called the air-side. The smooth surface of the liquid creates an almost perfectly flat bottom surface for the LC/prepolymer mixture. Initially, deionized water is chosen as the liquid substrate because water is nontoxic, nonflammable, cheap, readily available, does not leave unremovable residue, can be heated up to 100° C., and does not mix with thermotropic LC or the prepolymer. Water also does not dissolve the polymer after the polymerization process. Additionally, it does not wash out the LC from the PDLC film. The main disadvantage of water as a liquid substrate is its boiling point (about 212 degrees Fahrenheit (100° C.) at sea level). Since some of the LC/prepolymer mixtures may form homogeneous solutions at above 100° C., the aqueous medium can be altered or replaced with other liquid phase organic material, inorganic materials, and polymer solutions for higher temperature applications. Additionally, the topology of the PDLC films can be changed during photopolymerization via a templating process by using systems such as particle arrays, ions, linear polymer chains, vesicles, or liquid crystalline mesophases in the liquid phase, as disclosed in J. D. Clapper, L. Sievens-Figueroa, and C. A. Guymon, Chem. Mater. 20, 768-781 (2008).

### Example 3

### PDLC Film Morphology

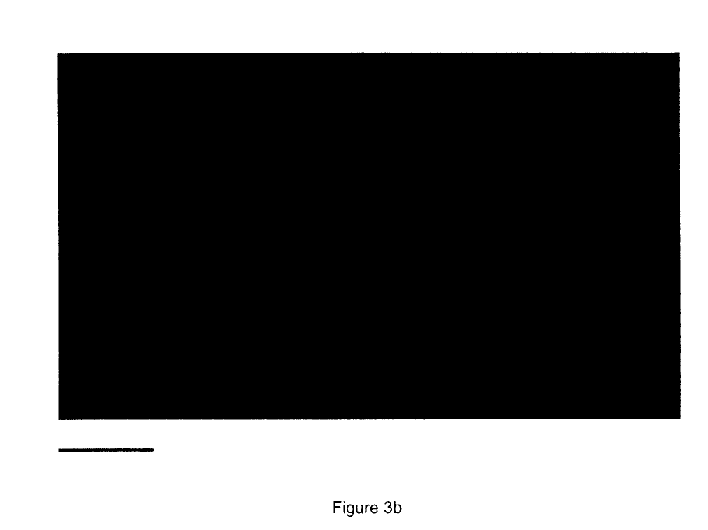

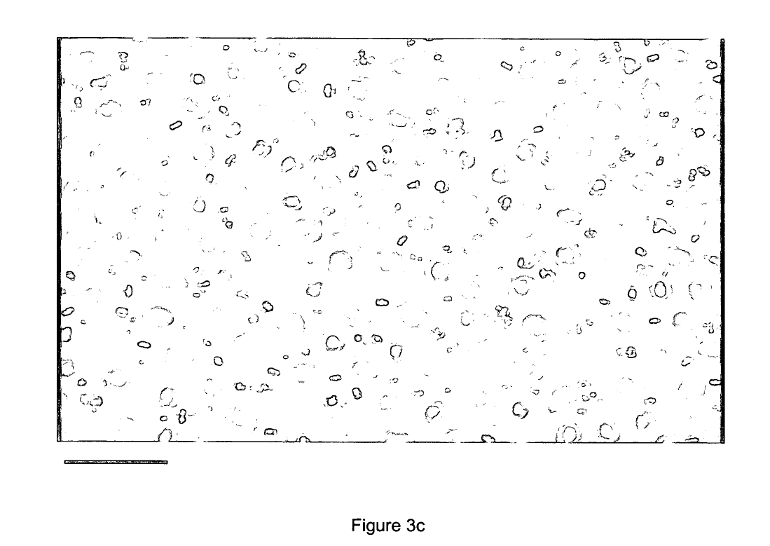

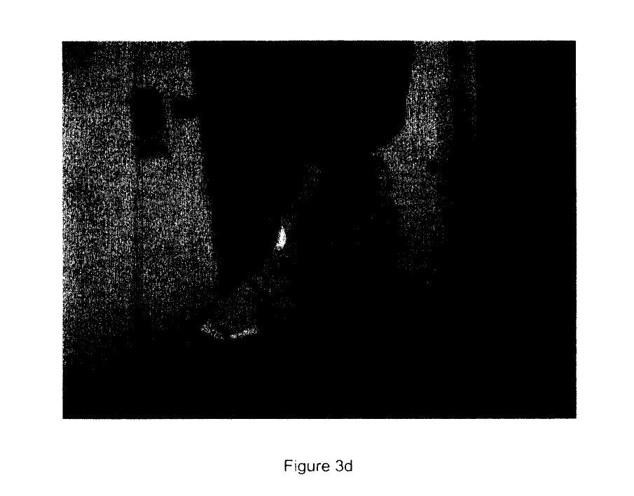

After the UV-curing process in Example 2, the PDLC film was drawn from liquid base 205 surface and dried at room temperature. In order to observe the morphology of the polymer matrix after the polymerization process, the polymerized PDLC film was kept in hexane over night to wash out LC material trapped inside the film. FIG. 3a illustrates the cross section of a substrate-free PDLC film after it is drawn from the surface of a liquid. With reference to FIG. 3a, liquid crystal droplets 301 consisting of a plurality of liquid crystal molecules 302 are dispersed in a polymer matrix 303. POM pictures were taken by digital camera (Hitachi) connected to an Olympus microscope (Model BX51) and to the computer. OM images were collected and recorded at the transmission mode and saved by software MGI VideoWave 4. FIGS. 3b and 3c show the top views of the PDLC film in Example 2. FIG. 3b shows the polarizing optical microscopy (POM) picture of interconnected polymer cavities when the polarizer is perpendicular to the analyzer. FIG. 3c shows the POM picture of interconnected polymer cavities when the polarizer is parallel to the analyzer. FIG. 3d shows the photograph of a substrate-free PDLC film with a thickness of approximately 100 μm. In FIGS. 3b and 3c, scales shown at the left bottom corner refer to a 20 micrometer length scale.

### Example 4

### PDLC Device

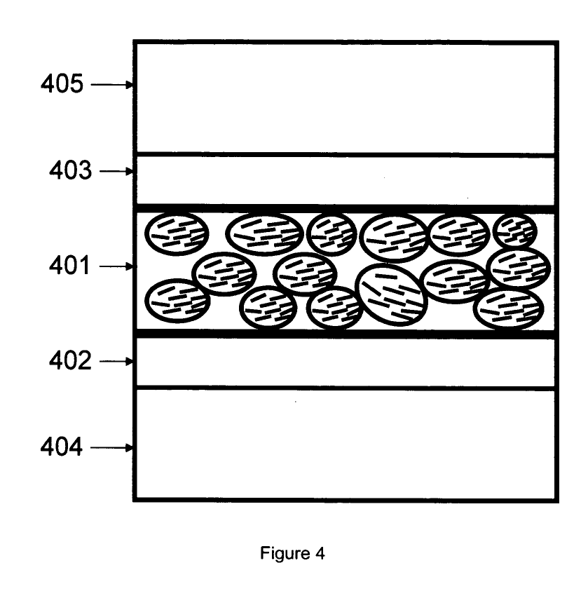

FIG. 4 schematically demonstrates the cross section of a liquid crystal device with a substrate-free PDLC film. With reference to FIG. 4, a substrate-free PDLC film 401 can be sandwitched between two conducting layers 402 and 403 (such as ITO, conducting polymers, and the like) and two substrates 404 and 405 (such as glass or plastics and the like) to form a switchable LC device. Any known method may be used to fabricate such a device, for example, lamination, encapsulation, or roll-to-roll manufacturing of each layer, as disclosed in, for example E. A. Buyuktanir, M. Mitrokhin, B. Holter, A. Glushchenko, and J. L. West, Jpn. J. Appl. Phys. 45 (5), 4146-4151 (2006); and A. Khan, I. Shiyanovskaya, T. Schneider, N. Miller, T. Ernst et al., J. of the SID 13 (6), 469 (2005).

### Example 5

### PDLC Device

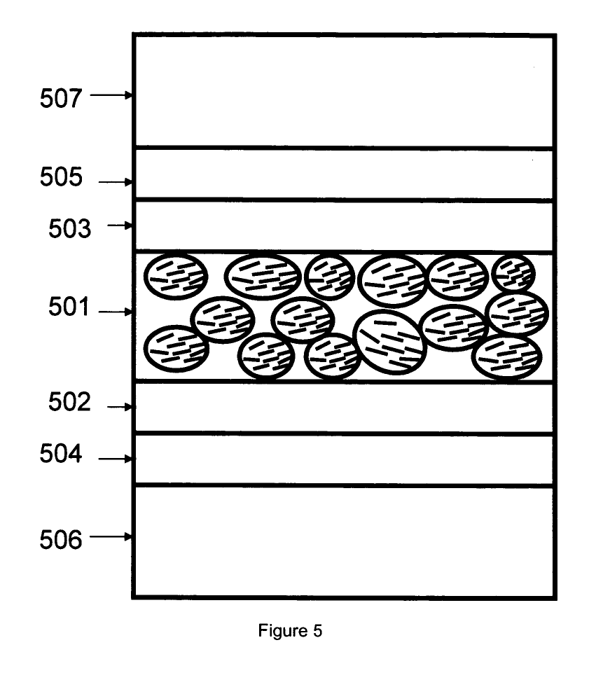

In fabricating a substrate-free polymer liquid crystal device, several other photo-polymerizable supporting layers can be dispensed on the liquid base as a first layer. For instance, for very low concentrations of LC (<30 wt %), the prepolymer can be dispensed onto the liquid surface first. Later, the LC/prepolymer mixture can be dropped on top of the floating prepolymer material. Another layer of prepolymer can also be added as a third layer over the LC/prepolymer layer. Finally, the prepolymer and the LC/prepolymer layers are polymerized altogether to obtain a substrate-free PDLC film, which can be used in a PDLC device as illustrated in FIG. 5. With reference to FIG. 5, the cross section of the liquid crystal device consists of a substrate-free PDLC film 501, top and bottom extra polymer supporting layers 502 and 503, two conductive layers 504 and 505, and two substrates 506 and 507. The first and/or the top polymer layers provide extra protective coatings and insulates the film from environmental effects.

### Example 6

### PDLC Fibers

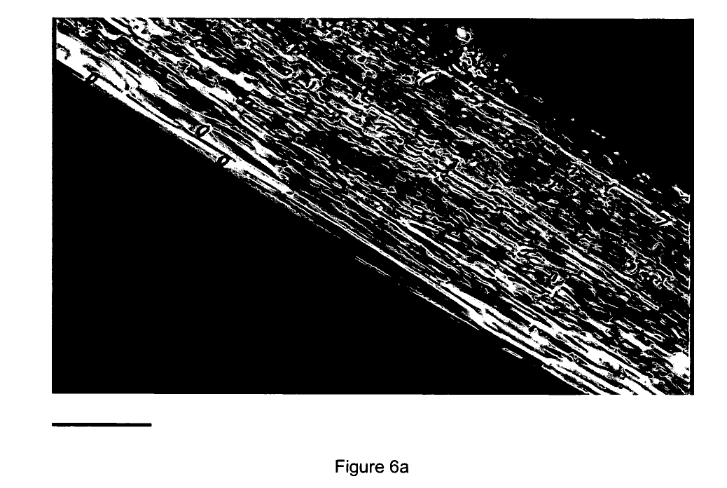

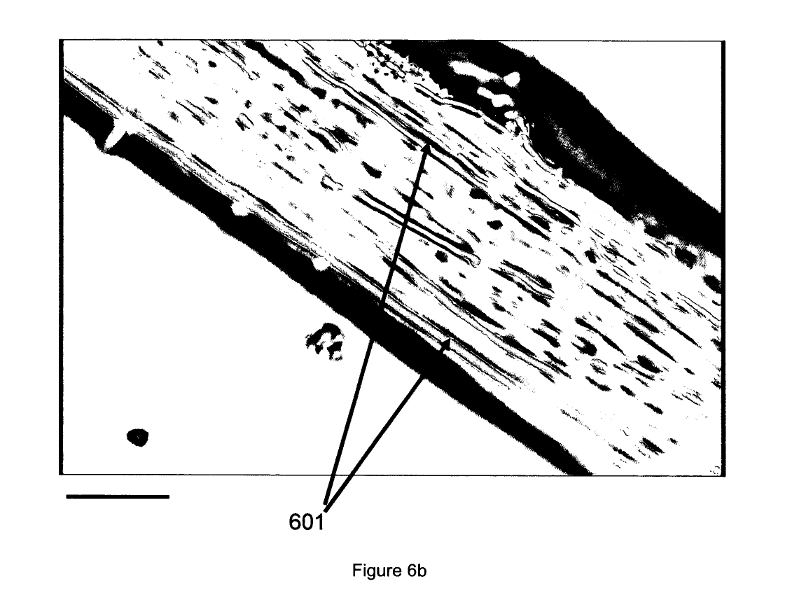

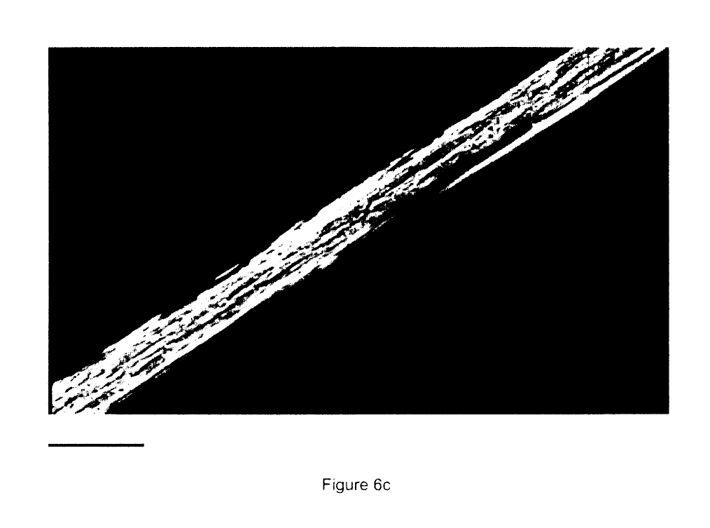

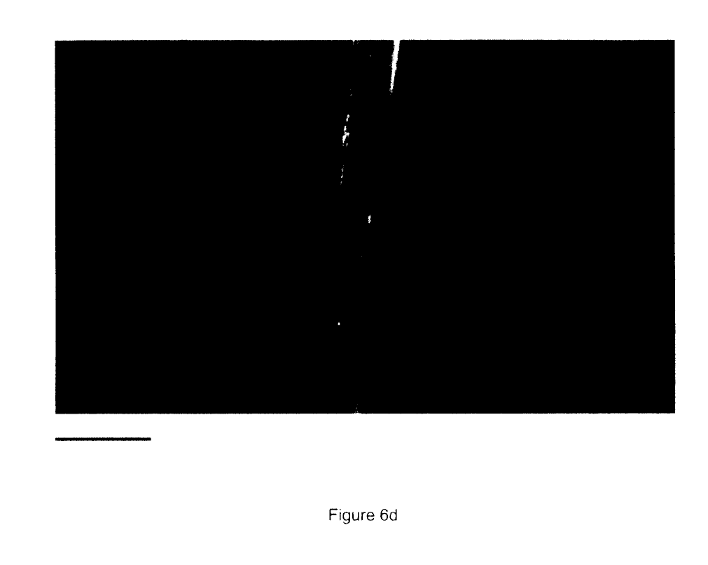

PDLC fibers were drawn from the surface of the polymerized thin substrate-free film and dried. The height and width of the PDLC fibers can be tuned between 1 micrometer to 100 micrometers. FIG. 6a shows the POM picture of a PDLC fiber (nematic phase) drawn from a polymerized substrate-free PDLC film prepared on the liquid surface with colors believed due to the birefringence of the LC domains dispersed in the polymer matrix, in which the long fiber axis is placed at 45 degree between crossed polarizer and analyzer, and the polarizer is perpendicular to the analyzer. With reference to FIG. 6a, LC domains and the polymer structure are highly oriented along the long axis of the fiber. Below T_{NI} at nematic phase, a PDLC fiber presents the birefringent colors of the LC material. If the fiber is aligned along one of the polarizers, it appears dark indicating that LC molecules are aligned along the fiber long axis.

FIG. 6b shows the POM picture of a PDLC fiber above nematic-isotropic transition temperature (T_{NI}). With reference to FIG. 6b, the material exhibits only the liquid phase, and the aligned bright lines 601 in the POM picture (with 50× microscope objective) are polymer chains. When the fiber is heated above T_{NI}, at which only the isotropic phase of the material exist, oriented polymer chains can be distinguished very easily.

FIGS. 6a and 6b are the same portion of the fiber. In FIG. 6a, the LC is at nematic phase and polarizers are crossed. In FIG. 6b, the LC is at the isotropic phase, but polarizers are set parallel to each other. Under crossed polarizer the image in FIG. 6b looks completely dark. In FIGS. 6a and 6b, scales shown at the left bottom corner refer to a 20 micrometer length scale.

FIGS. 6c and 6d show the POM images of a PDLC fiber demonstrating light polarization sensitivity of the fibers. In FIGS. 6c and 6d, scales shown at the left bottom corner refer to a 50 micrometer length scale. With reference to FIG. 6c, the long axis of PDLC fiber N is placed at 45 degree to polarizers. With reference to FIG. 6d, N is rotated to show the extinction pattern due to orientationally ordered LC domains along the stretched polymer structure, as shown in FIG. 6b (601). FIGS. 6c and 6d show that PDLC fiber is a light modulator and the PDLC fiber modulates the intensity of the beams of polarized light propagating through the fiber. Since LC molecules are aligned uniformly in the stretched polymer structure, they can manipulate the propagation of polarized light passing through the fiber. Maximum intensity of light is observed when the fiber is elongated between polarizer and analyzer, while minimum intensity is observed when the fiber is elongated along the polarizer or analyzer. Therefore light intensity and the polarization of the light passing through the fiber can be manipulated by rotating the fiber itself or by changing the orientation of LC molecules inside the fiber by applying an AC electric field.

The LC domains in the fiber can be electrically switched, and therefore, can be used as light modulating LC display. In addition, the size and shape of the drawn PDLC fiber can be changed by external situmulus, such as by stretching. Unidirectionally oriented LC domains dispersed in a stretched polymer structure can be used to produce electrically controlled devices by utilizing anisotropic light scattering properties of the LC domains. Highly oriented polymer structure coupled with oriented and birefringent LC domains can provide light amplitude and phase modulations.

### Example 7

### Substrate-Free PDLC Film

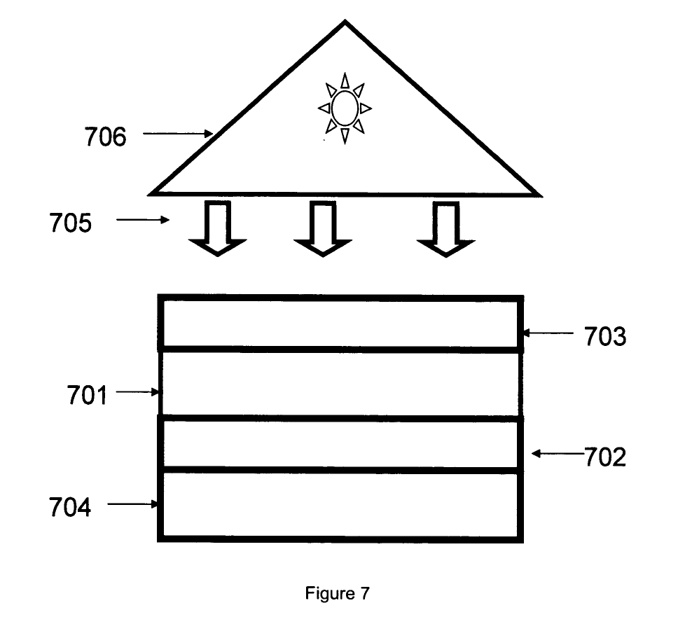

Similar to Example 2, FIG. 7 illustrates the cross section of an experimental set-up during UV irradiation in order to prepare a substrate-free PDLC film. With reference to FIG. 7, before exposing to UV irradiation 705 from a UV-light source 706, a LC and monomer mixture 701 is injected between top and bottom liquid surfaces 702 and 703, and followed by polymerization-induced phase separation process. Liquid bottom base 702 sits on a digitally controlled heating/cooling plate 704. In other words, the LC/monomer mixture can be injected inside the liquid phase prior to photopolymerization and UV-polymerized to for a film. This method sandwiches the mixture between two liquid surfaces acting as top and bottom substrates to form the PDLC film. After UV-polymerization, the PDLC film or fiber can be drawn as described above. Owing to such control and the versatility of the method, properties and features not available through traditional glass-based PDLC film preparation methods are possible.

### Example 8

### Substrate-Free PDLC Film

In Examples 8 and 9, hexane and tetrahyrofuran were purchased from Sigma-Aldrich (St. Louis, Mo.). Commercially available 4-pentyl-4′-cyanobiphenyl (5CB) and E7 liquid crystals were obtained from Merck Licristal EM Chemicals. The morphology of the polymer matrix was examined by using a JEOL JSM-6300V SEM. Samples for SEM were coated for 30s with Au—Pd (gold-palladium) using Ar (argon) inert gas plasma. After UV curing process, the PDLC films and fibers were immersed in hexane/tetrahyrofuran (2:1 v/v) solution over night to wash out LC material.

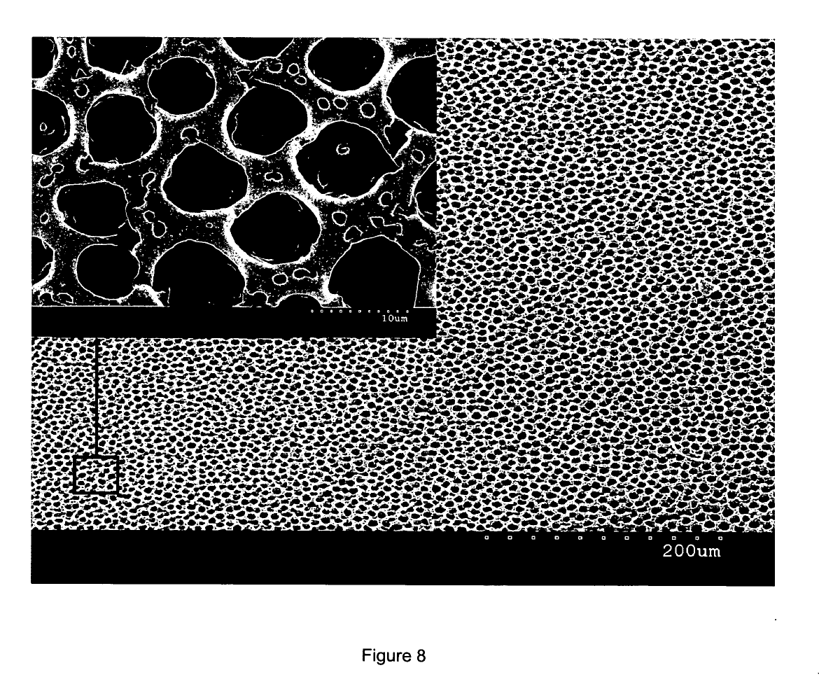

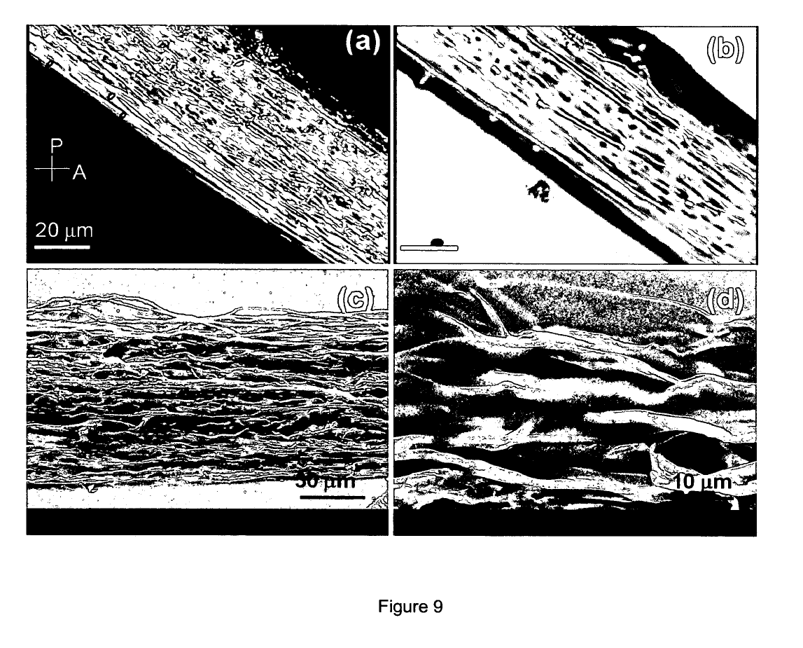

Similar to previous examples, the substrate-free PDLC films and fibers were composed of nematic LC (E7, Merck) and thiol-ene based monomer (N0A65) (50/50 wt %), and fabricated on an aqueous surface. To observe the morphology of the polymer matrix after the polymerization process, the polymerized PDLC film was kept in THF/hexane over night to wash out LC material trapped inside the film. FIG. 8 demonstrates the scanning electron microscopy (SEM) image of the cross section of 5 μm thick substrate-free PDLC film. The image shows a very ordered and interconnected polymer microstructure such as cavities at the 5 μm thick section of the film. The average diameter of the polymer cavities is about 7 μm. The formation of this ordered structure shows that phase separation process on the water surface generates LC domains. The LC material is encapsulated in a regular array of microcavities. These domains are nearly spherical and uniform in size, and are arranged in quasi-2D ordered patterns. Inset in FIG. 8 shows the interconnected polymer cavities at higher magnification.

### Example 9

### PDLC Fibers

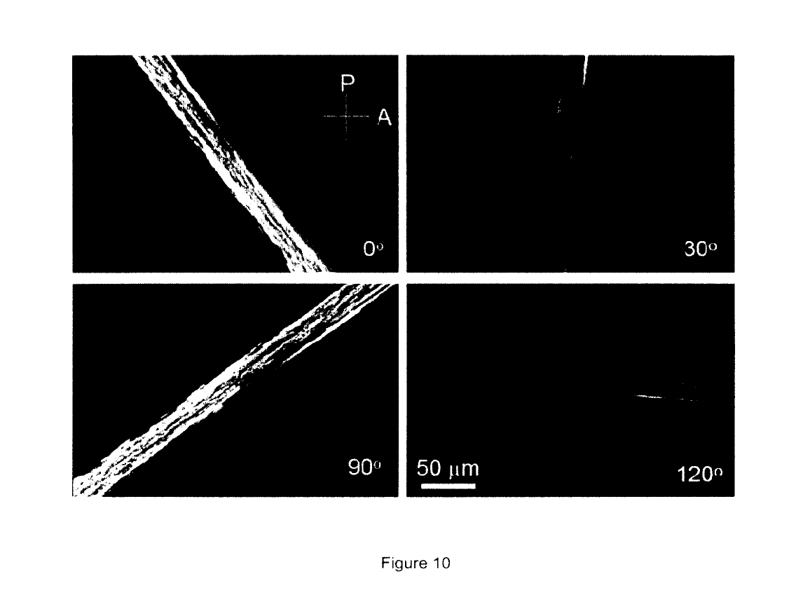

PDLC fibers were similarly drawn from the polymerized thin substrate-free PDLC films of Example 8. The polarized optical microscopy (POM) images of the PDLC fiber are shown in panels (a), (b), (c) and (d) in FIG. 9. At a temperature below nematic-isotropic phase transition temperature (T_{NI}˜58° C. for E7) in the nematic phase, the PDLC fiber presents birefringent colors as a result of the optical anisotropy of the LC material, as shown in panel (a) in FIG. 9. The fiber as shown in panel (a) is in the nematic phase, and the long fiber axis is placed at 45° between crossed polarizer (P) and analyzer (A). The colors are due to the birefringence of the LC domains. When the fiber is heated above T_{NI}, at which E7 is an isotropic liquid, the birefringent texture of nematic phase disappears and the oriented polymer chains can be distinguished very easily, as shown in panel (b) in FIG. 9. Panel (b) demonstrates an appearance of the fiber above T_{NI} of LC, where the material exhibits only liquid phase. The bright lines seen in the POM picture in Panel (b) are polymer chains. The microscope objective was 50× for panel (b) in FIG. 9. The nematic mesophase was re-formed in the cavities of polymer matrix below T_{NI}. The SEM images of the PDLC fiber with different magnifications, as shown in panels (c) and (d) in FIG. 9, confirm that, during the drawing process, the polymer cavities were highly elongated and mostly replaced with a fibrilar polymer structure. This fibrilar structure aligns the nematic LC domains uniformly along the long axis of the fiber. As a result, PDLC fibers are very sensitive to the polarization direction of the incident light propagating through the sample. The cylindrical micron-sized cavities of the fiber structure imposed the orientational ordering at the walls of polymer and aligned the LC material along the stretching. When the fiber was rotated on the plane of observation from its initial position at 0° to the final position at 120° (CW) under crossed polarizers, the polarization dependent light transmission characteristics can be clearly observed, as shown in FIG. 10. When the fiber was aligned along one of the polarizers, it appeared dark indicating that the LC director is aligned along the fiber long axis.

### Example 10

### Electro-Optical Characterization of the Fibers

For optical and electro-optical characterization, the PDLC fibers of Example 9 were sandwiched between two indium-tin-oxide (ITO) coated glass (Corning, 1.1 mm thick) substrates. A square wave electric field was supplied by a function generator (30 MHz Standford Research Systems) and a wideband amplifier (Krohn-Hite Corp.). E7 with positive dielectric anisotropy (Δ∈=14) has the nematic-isotropic phase transition temperature, T_{NI}, at 58° C. All the materials were used without further purification. The LC fiber cell corners (˜30 μm thick) were fixed with epoxy-based glue. An electric field was applied to the cells via ITO electrodes. A square wave alternating current (AC) electric field was supplied by a function generator (Hewlett Packard 33120A, 15 MHz) and a wideband amplifier (FLC electronics F20 AD). 1 kHz square waveform was produced repetitively in a burst mode with the function generator. The pulse duration was 100 ms, i.e. the function generator sends a voltage pulse with a frequency of 1 kHz for a period of 100 ms and switches off for a period of 100 ms. The amplitude of the voltage pulse (Vₚ) was varied from 0 to 160 V. The intensity of transmitted light through the cell was measured using a photodiode placed at an eyepiece of an Olympus microscope by keeping the illumination and the magnification constant. The 10× microscope objective was used to collect the transmitted light intensity. The optical response characteristics of the fibers and the voltage pulses were monitored by a computer-based oscilloscope and PC software from Pico Technology Ltd. Finally, all the results were digitally saved to the computer, and results were plotted using OriginPro 7 Software (OriginLab Corp.).

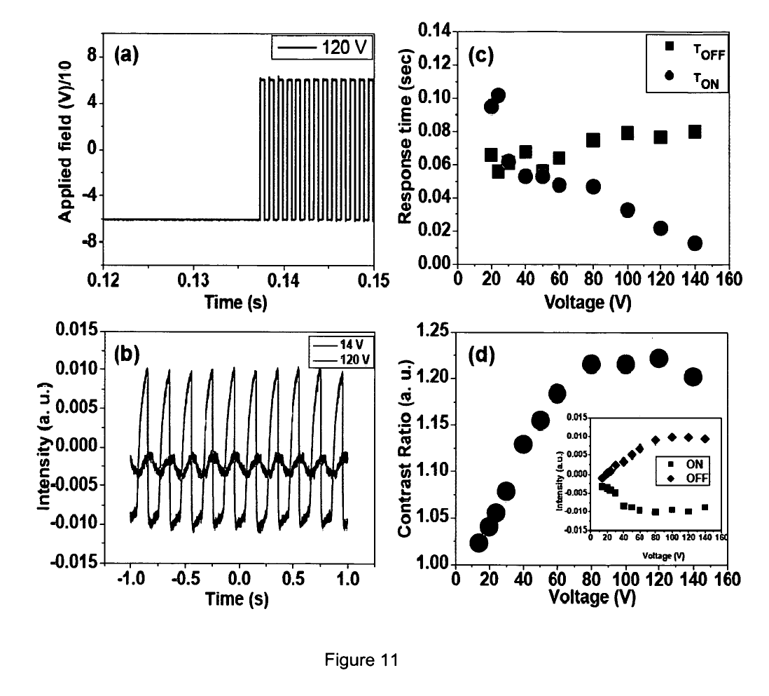

The fibers can be electrically switched upon application of an electric field, and the relaxation time of the fiber is faster than traditional PDLC films. The electro-optical characterizations of the fibers are shown in FIG. 11. The switching time upon application of 80 V was 47 ms, and the relation time after removing the voltage was 75 ms for the PDLC fiber. Time OFF (0%-90%) and time ON (100%-10%) values were calculated based on a 90% change in the light intensity ΔI, which was the difference between maximum and minimum intensity (ΔI=Iₘₐₓ−Iₘᵢₙ). The maximum intensity Iₘₐₓ, was obtained when the field was zero, but the minimum intensity Iₘᵢₙ was obtained when the field was applied. With reference to FIG. 11, panel (a) shows the applied square-wave AC electric field (0 to 120 V) at 1 kHz; panel (b) shows typical electro-optical responses of the PDLC fiber upon application of the square-wave voltage pulses of 14 V and 120 V at 1 kHz under crossed polarizers; panel (c) shows the response time characteristics as a function of an applied voltage; and panel (d) sows the relative contrast ratio [CR=(Iₘₐₓ+0.1)/(Iₘᵢₙ+0.1)] as a function of an applied voltage, and the inset in panel (d) is the field-induced light transmission characteristics of the fibers. These results also showed that the electro-optical properties of the LC mesophase were well-preserved in the core of the fiber.

The composite fibers can be electrically switched upon application of an AC-electric field. The invention provides the first electrically switchable and light modulating LC/polymer fibers for use in stimuli responsive optical fibers, textiles, and optoelectronic devices.

The invention has been described with reference to the embodiments presented. Obviously, modifications and alterations will occur to others upon reading and understanding the preceding detailed description. It is intended that the embodiments provided be construed as including all such modifications and alterations insofar as they come within the scope of the appended claims or the equivalents thereof.

1. A film comprising a polymer dispersed liquid crystal (PDLC) which exists independently from a substrate.

2. The film according to claim 1, wherein the substrate is a rigid and transparent material such as glass and plastic.

3. The film according to claim 1, wherein the concentration of the liquid crystal is generally from about 10% to about 95% by weight, based on the total weight of the polymer and the liquid crystal.

4. The film according to claim 1, wherein the liquid crystal material is in the mesophase, and the mesophase is selected from nematic; cholesteric (chiral nematic); smectic, such as smectic A, smectic C, Smectic C* (chiral smectic C), ferroelectric and antiferroelectric smectic mesophases, and higher order smectics of B, E, G, H, J, and K-types; banana mesophase; lyotropic chromonic liquid crystals; and columnar mesophase.

5. The film according to claim 1, wherein the polymer is made from photo-polymerizable monomers selected from thiol-ene systems; monomers such as acrylates through radical polymerization; ring-opening monomers such as epoxides through cationic polymerization; photo-polymerizable blends such as nematogenic monomer and chiral dopants and polyurethane/acrylate blends; photo-polymerizable cholesteric mixtures; photo-polymerizable biomaterials; any copolymer thereof such as block copolymer; and any mixture thereof.

6. The film according to claim 1, wherein the polymer is made from thermal-polymerizable monomers selected from epoxy resins, polyurethanes, acrylic resins, matrices of bismaleidimide, phenolic, polyesters, polyimides, blends of polymer and monomers, and blends of monomers.

7. The film according to claim 1, wherein the polymer is made from a combination of thermal-polymerizable monomers and photo-polymerizable monomers.

8. The film according to claim 1, further comprising one or more additives selected from dyes such as positive and negative dichroic dyes, dopants, surfactants, ferroelectric particles, ferromagnetic particles, macromolecules, piezoelectric particles, multifunctional monomers, azo dyes, biological materials, colloidal particles, mesogens, gold particles, metal particles, adhesives, chemical markers, fluorescent dyes, minerals, and quantum dots.

9. The film according to claim 1, which comprises a layer of polymer dispersed liquid crystal (PDLC), and one layer of polymer free of liquid crystal on one side of the layer of polymer dispersed liquid crystal (PDLC).

10. The film according to claim 1, which comprises a layer of polymer dispersed liquid crystal (PDLC), and two layers of polymer free of liquid crystal on two sides of the layer of polymer dispersed liquid crystal (PDLC) respectively.

11. A fiber made from a film comprising a polymer dispersed liquid crystal (PDLC) which exists independently from a substrate.

12. The fiber according to claim 11, which is woven into a fabric.

13. A PDLC device including a film comprising a polymer dispersed liquid crystal (PDLC) which exists independently from a substrate.

14. The PDLC device according to claim 13, which is selected from a light modulating device, a display device, a light shutter, a switchable window, a projection display, a direct-view display, portable electronics, high-tech fabrics and textiles, adaptive liquid crystal lenses with variable focus, curved optical devices, tunable filters, optical memory storage, bistable devices, holographically patterned substrate-free PDLC films, substrate-free PDLC photonic materials, and a flexible LC display.

15. The PDLC device according to claim 13, further including one medium onto which the film is transferred or two mediums between which the film is sandwiched.

16. The PDLC device according to claim 15, in which the medium is selected from an indium-tin-oxide coated glass substrate, an indium-tin-oxide coated plastic substrate, a flexible or rigid surface coated with a conducting layer, a textile surface embedded with an organic-thin-film-transistor (OTFT), a conducting polymer, an inorganic conductor, and a hybrid organic-inorganic conductor.

17. A PDLC device including a fiber made from a film comprising polymer dispersed liquid crystal (PDLC) which exists independently from a substrate or a fabric made from the fiber.

18. The PDLC device according to claim 17, which is selected from a stimuli responsive optoelectronic fiber/fabric, an optical sensor, and a light modulating device.

19. A method of preparing a film comprising polymer dispersed liquid crystal (PDLC) which exists independently from a substrate, which comprises:
providing a first liquid base;
providing a mixture comprising liquid crystal and monomers, wherein the liquid crystal and the monomers are substantially insoluble in the first liquid base;
spreading the mixture on the surface of the first liquid base; and
forming a layer of polymer matrix dispersed with liquid crystal domains on the surface of the first liquid base.

20. The method according to claim 19, in which the first liquid base comprises water, organic solvents, polymer solutions, or any combination thereof.

21. The method according to claim 19, in which the step of forming a layer of polymer matrix dispersed with liquid crystal domains is accomplished by UV curing, thermal curing, solvent evaporation, or any combination thereof.

22. The method according to claim 19, in which the step of forming a layer of polymer matrix dispersed with liquid crystal domains is accomplished by polymer-induced phase separation (PIPS).

23. The method according to claim 22, in which the polymer-induced phase separation (PIPS) is conducted with a UV radiation dose of from about 0.01 milliWatt per square centimeter (mW/cm²) to about 500 mW/cm².

24. The method according to claim 22, in which the polymer-induced phase separation (PIPS) is conducted at a polymerization temperature of from about 0° C. to about 250° C.

25. The method according to claim 19, which comprises:
providing a first liquid base;
providing a second liquid base;
providing a mixture comprising liquid crystal and monomers, wherein the liquid crystal and the monomers are substantially insoluble in the first and second liquid bases;
spreading the mixture on the surface of the first liquid base to form a layer;
spreading the second liquid base on the layer of the mixture; and
forming a layer of polymer matrix dispersed with liquid crystal domains between the first liquid base and the second liquid base.

26. A method of preparing a PDLC fiber, which comprises:
providing a first liquid base;
providing a mixture comprising liquid crystal and monomers, wherein the liquid crystal and the monomers are substantially insoluble in the first liquid base;
spreading the mixture on the surface of the first liquid base;
forming a PDLC layer of polymer matrix dispersed with liquid crystal domains on the surface of the first liquid base; and
elongating the PDLC layer to form a PDLC fiber.

27. The method according to claim 26, in which the PDLC layer of polymer matrix is cured completely in the steps of forming a PDLC layer of polymer matrix dispersed with liquid crystal domains on the surface of the first liquid base; and
elongating the PDLC layer to form a PDLC fiber.

28. The method according to claim 26, in which the PDLC layer of polymer matrix is cured incompletely in the steps of forming a PDLC layer of polymer matrix dispersed with liquid crystal domains on the surface of the first liquid base; and elongating the PDLC layer to form a PDLC fiber; and further comprising:
transferring the fiber onto another surface to be cured with UV light, heat, or combination thereof.

29. The method according to claim 26, further comprising:
modifying the surface characteristics of the fiber by dipping, spraying, embedding or coating the fiber with another layer of polymer, curable monomers, surfactants, metal electrodes, conducting metal, organic or inorganic materials, or any combination thereof.

30. A method of preparing a PDLC device, which comprises:
providing a first liquid base;
providing a mixture comprising liquid crystal and monomers, wherein the liquid crystal and the monomers are substantially insoluble in the first liquid base;
spreading the mixture on the surface of the first liquid base;
forming a PDLC layer with polymer matrix dispersed with liquid crystal domains on the surface of the first liquid base; and
transferring the PDLC layer onto a medium or sandwiching the PDLC layer between two mediums.

31. The method according to claim 30, in which the medium is selected from an indium-tin-oxide coated glass substrate, a plastic substrate, a flexible or rigid surface coated with conducting layer, a textile surface embedded with organic-thin-film-transistor (OTFT), a conducting polymer, an inorganic conductor, electrospun or melt spun conducting fibers, and a hybrid organic-inorganic conductor.
